(19) United States
(12) Patent Application Publication
(10) Pub. No.: US 2023/0179635 A1
(43) Pub. Date: Jun. 8, 2023

(54) ENHANCED ZERO TRUST SECURITY SYSTEMS, DEVICES, AND PROCESSES

(71) Applicant: CenturyLink Intellectual Property LLC, Broomfield, CO (US)

(72) Inventors: John SCHIEL, Broomfield, CO (US); Joe DIETZ, Broomfield, CO (US)

(73) Assignee: CenturyLink Intellectual Property LLC, Broomfield, CO (US)

(21) Appl. No.: 17/656,555

(22) Filed: Mar. 25, 2022

Related U.S. Application Data
(60) Provisional application No. 63/264,576, filed on Nov. 24, 2021.

(51) Int. Cl. H04L 9/40

(52) U.S. Cl. CPC H04L 63/20

(57) ABSTRACT

This disclosure describes systems, methods, and devices related to identification and assessment of security threats to a computer system using zero trust security. A method may include receiving, at a policy enforcement device of a computer network, first data from a first subsystem of the computer network; receiving, at the policy enforcement device, second data from a second subsystem of the computer network, the first subsystem different than the first subsystem; identifying, by the policy enforcement device, based on a comparison of at least one of the first data or the second data to a security policy, a security threat to the computer network; and causing, by the policy enforcement device, a threat intelligence device of the computer network to determine a risk of the security threat.

### CROSS-REFERENCE TO RELATED PATENT APPLICATION(S)

This application claims the benefit of U.S. Provisional Application No. 63/264,576, filed Nov. 24, 2021, the disclosure of which is incorporated by reference as set forth in full.

### TECHNICAL FIELD

Embodiments of the present invention generally relate to systems and methods for implementing a zero trust security system.

### BACKGROUND

Computer systems protect security of users and data. Sometimes devices and users may be trusted to perform actions, such as accessing computer resources. For example, network proximity and specific endpoints may be used to determine whether a user or device is trusted. In computer environments with many resources and subsystems, trusting users and devices may not be preferable to system users. In addition, security enforcement of a computer subsystem may be specific to the subsystem, so in a computer system with many subsystems, the subsystems may have dedicated security enforcement mechanisms.

In view of the foregoing, there is a need for enhanced security for computer systems with multiple subsystems, such as a complex computer networking environment.

### SUMMARY

A centralized security policy enforcement engine may provide real-time security policy evaluation of multiple subsystems of a computer system. The security policy enforcement engine may enforce a zero trust security policy when analyzing data ingested from the subsystems. The security policy enforcement engine may be responsible for the ultimate decision regarding whether to grant access to a resource.

The security policy enforcement engine may generate outputs regarding access to allow users based on a detected threat.

A threat intelligence engine may be triggered by an identified policy violation and determine the significance of a threat. When a threat is determined to be significant, the threat intelligence engine and/or the security policy enforcement engine may mitigate the threat.

### BRIEF DESCRIPTION OF THE DRAWINGS

FIG. 1 illustrates an exemplary zero trust environment in accordance with one embodiment.

FIG. 2 is a flowchart illustrating a process for zero trust security policy enforcement in accordance with one embodiment.

FIG. 3 is a flowchart illustrating a process for zero trust security policy enforcement in accordance with one embodiment.

FIG. 4 is a diagram illustrating an example of a computing system that may be used in implementing embodiments of the present disclosure.

### DETAILED DESCRIPTION

Aspects of the present disclosure involve systems, methods, and the like, for distributing or otherwise controlling routing information in a telecommunications network.

A zero trust security model never trusts a device or user, regardless of device proximity, connections to private networks, previously performed actions, or the like. Zero trust security require verification of a user or device each time that the user or device attempts to access resources or perform other actions in a computer system. Zero trust security may always authenticate and authorize based on all available data points, may limit user access with just-in-time and just-enough-access (JIT/JEA), risk-based adaptive policies, and data protection. Zero trust security may minimize the blast radius of a breach and segment access of a breach, verifying end-to-end encryption and using analytics to gain visibility, identify threats, and improve threat mitigation.

Diverse computer systems may employ many subsystems, such as identity management systems, data management systems, application management systems, device management systems, infrastructure systems (e.g., infrastructure as a service, platform as a service, serverless computing, containers, etc.), network systems (e.g., network delivery, internal micro-segmentation, etc.), and the like. In some existing techniques, each of the subsystems may have its own security policy enforcement. For example, an identity management system may use an identity manager to verify and authenticate users. A device management system may identify devices and assess device risks. A data management system may classify, label, and encrypt data. However, dedicated security enforcement of one subsystem may not collect and analyze data from other subsystems to identify policy violations that may indicate threats. For example, subsystems may be provided by different vendors where each vendor has its own security for its subsystem. The different vendors’ security are not compatible making management of security in multiple subsystems challenging.

Therefore, there is a need for an enhanced system to collect data from the different subsystems of a computer system to allow for centralized assessment of the data for zero trust security enforcement across the computer system.

In one or more embodiments, a centralized security policy enforcement engine may provide real-time security policy evaluation of multiple subsystems of a computer system. The security policy enforcement engine use data provided by the subsystems rather than replacing the subsystems. The security policy enforcement engine may ingest data from any of the subsystems to assess for security policy compliance. For example, an identity and access management (IAM) subsystem may provide identities to the security policy enforcement engine (e.g., from requests to access computer resources). The data ingested by the security policy enforcement engine may come from application programming interface (API) or other activity logs, JavaScript Object Notifications (JSONs), telemetry, governance/compliance data, threat data, and the like. The security policy enforcement engine may enforce a zero trust security policy when analyzing data ingested from the subsystems. The security policy enforcement engine may be responsible for the ultimate decision regarding whether to grant access to a resource. The security policy enforcement engine may be integrated with user directory stores to assess accounts, roles, and permissions continually. To enforce access control policies governed by the security policy enforcement engine, a micro-segmentation engine may be in place, and may include cloud native micro-segmentation tools, and internal identity-aware policy engines that may restrict and limit access between assets running in on-premises data centers and cloud provider environments.

In one or more embodiments, the security policy enforcement engine may generate outputs regarding access to allow users based on a detected threat. For example, the output may recommend no access be granted, read only public access, read only confidential access, read/write public and confidential access, read/write public, confidential, and highly confidential access, or unlimited access (e.g., administrator, root, enable, owner, etc.). There may be time-based considerations when moving to a higher access level.

In one or more embodiments, a threat intelligence engine may be triggered by an identified policy violation. In particular, when the security policy enforcement engine detects a violation of a security policy, the threat intelligence engine may be triggered to assess the threat of the violation. Significance of a threat may be based on a number of times the violation has occurred, the type of violation, data or other resources impacted, and the like. When a threat is determined to be significant, the threat intelligence engine may facilitate the generation of notifications to users for further investigation of the violation, may automatically shut off access to devices, resources, and the like, may deactivate or limit access of user accounts or devices, may alter user or device roles, and the like to mitigate the threat.

In one or more embodiments, because the data from different subsystems may be in different formats, the data may be normalized by the subsystems prior to providing the data to the security policy enforcement engine. Alternatively, the security policy enforcement engine or another engine of networking system may normalize the data for the security policy enforcement engine to analyze. In this manner, data normalization may include converting data to a particular format, structure data type, or the like.

The above descriptions are for purposes of illustration and are not meant to be limiting. Numerous other examples, configurations, processes, etc., may exist, some of which are described in greater detail below. Example embodiments will now be described with reference to the accompanying figures.

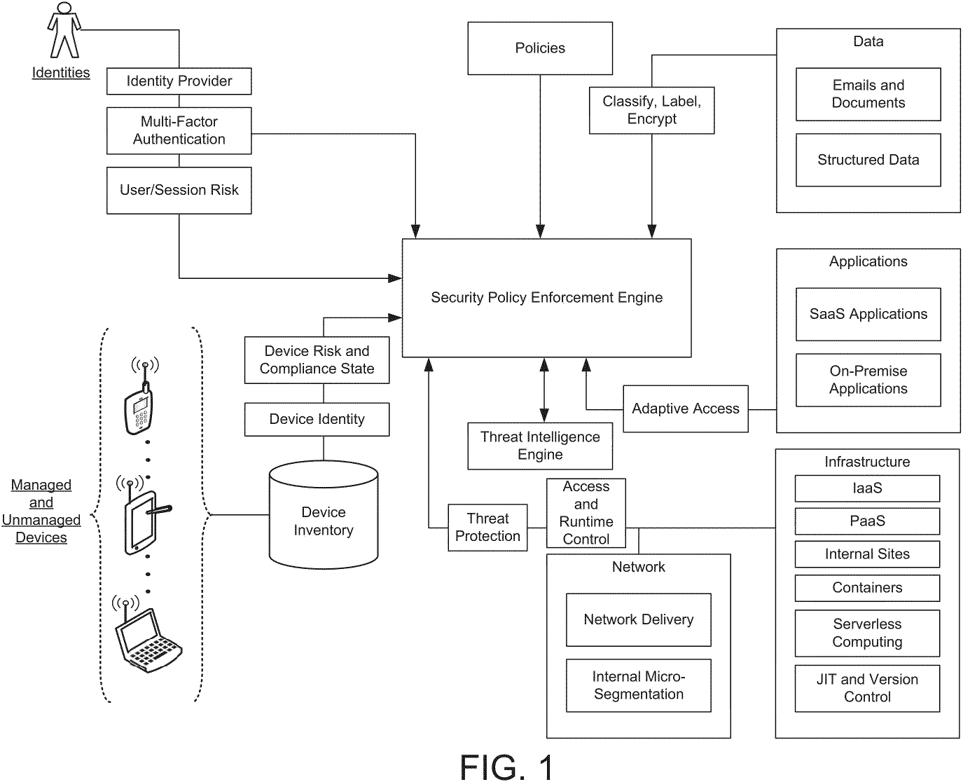

FIG. 1 illustrates an exemplary zero trust environment 100. The zero trust environment 100 may include a security policy enforcement engine that evaluates organization and other policy for compliance. A threat intelligence engine may be triggered by the detection of a non-compliance by the security policy enforcement engine. The threat intelligence engine may determine the significance of the threat so that the security policy enforcement engine may mitigate the threat.

In one or more embodiments, the zero trust environment 100 may represent at least a portion of a cloud-based or otherwise remotely accessible network for one or multiple devices, and may include one or more virtual private networks and clouds, and/or multiple networks dedicated to respective organizations. The zero trust environment 100 may require all users and devices to authenticate and be authorized to use resources in the zero trust environment 100 (e.g., the subsystems and/or other resources, such as data storage, documents, workflows, network accounts, elastic computing, and the like), as opposed to network segments, for example, as the network location or ownership may not be primary factors for security decisions. Instead, IAM, multi-factor authentication, biometrics, public key cryptography, and or certificates may verify a user’s identity. The users and devices may need to be validated continuously even if they have been previously authenticated, authorized, and evaluated. In this manner, the zero trust environment 100 may operate from the premise that no network edge is in place and/or that previous authentication or other validation of a user or device does not preclude further authentication or validation. The zero trust environment 100 may leverage NIST standards (e.g., NIST 800- standards such as NIST 800-207, NIST 800-53, etc.)

As shown, the security policy enforcement engine may ingest data from a variety of subsystems, such as identity subsystems, device subsystems, data subsystems, application, subsystems, infrastructure subsystems, and network subsystems (a list of subsystems that is not intended to be limiting).

Regarding identity data, when an identity attempts to access a resource of the zero trust environment 100, the security policy enforcement engine may verify the identity with strong authentication, and ensure access that the access is compliant and typical (e.g., based on one or more policies and/or past activity of the identity) for the identity. For example, the security policy enforcement engine may follow least privilege access principles. Identities may be fragmented across a number of systems. For a user, this may result in numerous and insecure passwords. Without visibility and ownership over these fragmented identities, IT and security teams are left with potentially large windows for attackers to exploit access into individual systems.

Lifecycle refers to the policies, processes and technologies for provisioning, modification and de-provisioning of digital identities in an organization. Governance is responsible for establishing the requirements for identities and assuring their reliability in line with the business objectives and risk landscape of the organization.

It may be beneficial to consolidate identities under one identity and access manager (IAM) system, across on-premises and cloud.

Single sign-on prevents users from leaving copies of their credentials in various apps and helps avoid users get used to surrendering their credentials due to excessive prompting. Layering a second factor of authentication to that centralized, identity access point further helps to mitigate attacks targeting credentials.

Identity management infrastructure may provide significant information for detailed analysis. When combined with telemetry from other sources, this logging may be an element for the advanced visibility zero trust provides.

Zero trust-ready identity infrastructure may be capable of calculating risk scores from a broad variety of information sources beyond user identity and source machine. Factors such as device ownership, whether this user commonly uses this machine to make a request, location of the requesting device, time of day and other historical, associational or behavioral factors may affect the riskiness of allowing the transaction.

Trust is also not absolute, adaptive authentication is continuously monitored for change in signals, re-prompting for authentication and authorization should an aspect of that user’s context change.

Regarding device (e.g., endpoint) data, once an identity has been granted access to a resource, data can flow to a variety of different endpoints-from Internet of Things (IoT) devices to smartphones, BYOD to partner-managed devices, and on-premises workloads to cloud-hosted servers. This diversity creates a significant attack surface area. The security policy enforcement engine may monitor and enforce device health and compliance for secure access.

Endpoints may be registered with cloud identity providers. In order to monitor security and risk across multiple endpoints used by any one person, visibility in all devices and access points accessing computer resources may be beneficial.

Access may be granted only to managed and compliant endpoints and applications. The security policy enforcement engine may set compliance rules to ensure that devices meet minimum security requirements before access is granted, and may set remediation rules for noncompliant devices so that people know how to resolve the issue.

Data loss prevention (DLP) policies may be enforced for corporate devices and bring-your-own devices (BYODs). The security policy enforcement engine may control what the user can do with the data after they have access. For instance, the security policy enforcement engine may restrict file saving to untrusted locations (such as local disk), or restrict copy-and-paste sharing with a consumer communication application or chat application to protect data.

Endpoint threat detection may monitor device risk. The security policy enforcement engine may use a single pane of glass to manage all endpoints in a consistent way and use a security information and event management (SIEM) to route endpoint logs and transactions such that there may be fewer, but actionable, alerts.

Access control may be gated on endpoint risk for both corporate devices and BYOD. The security policy enforcement engine may integrate data for device compliance policies and device Conditional Access rules. The device risk may then directly influence what resources will be accessible by the user of that device.

The security policy enforcement engine may use adaptive and continuous monitoring / device health. In particular, the security policy enforcement engine may use end point detection and response (EDR) tools, extended detection and response (XDR) tools, managed detection and response (MDR) tools, and/or other detection and response tools to monitor and detect threats on the endpoint and notify when alerts are found. The security policy enforcement engine may determine whether to remove access until the threat is removed. Additionally, the security policy enforcement engine may check the posture health of the device to ensure it is in compliance with the security policy engine.

Regarding data subsystem data (e.g., emails, documents, structured data, etc.), the data should remain secure where possible even when leaving devices, applications, infrastructure, and networks controlled by an organization. Data subsystems may classify, label, and encrypt data, and the security policy enforcement engine may restrict access to data based on such attributes.

All data may be classified and labeled. The security policy enforcement engine may protect the most sensitive data with encryption and restrict access to content to which sensitivity labels are applied.

To avoid issues with data not being labeled manually, or labels being applied inaccurately, the security policy enforcement engine may automate data classification.

The zero trust environment 100 may have large amounts of data that can be challenging to adequately label and classify, and may use machine learning for smarter classification.

To comply with business standards and industry regulations, the zero trust environment 100 must protect sensitive information and prevent its inadvertent disclosure.

The security policy enforcement engine may need to discover data across an entire organization and classify all data by sensitivity level.

Sensitive data may need to be protected by data protection policies that label and encrypt data or block over-sharing. This ensures only authorized users are able to access the data, even when data travels outside of a corporate environment.

The security policy enforcement engine may continuously monitor sensitive data to detect policy violations and risky user behavior. This allows for appropriate action, such as revoking access, blocking users, and refining protection policies.

When data and sensitive content is understood, labeled, and classified, the security policy enforcement engine may: (1) Inform and enforce policy decisions to block or remove emails, attachments, or documents; (2) Encrypt files with sensitivity labels on device endpoints; (3) Auto-classify content with sensitivity labels through policy and machine learning; and (4) Track and monitor sensitive content using policies as the content travels inside and outside of a digital estate.

Regarding application subsystem data, applications and APIs may provide an interface by which data is consumed by the security policy enforcement engine. The applications and APIs may be legacy on-premises applications, lifted-and-shifted to cloud workloads, or software as a service (SaaS) applications. Applying controls and technologies to discover shadow information technology may ensure appropriate in-application permissions, gate access based on real-time analytics, monitoring for abnormal behavior, control of user actions, and validation of secure configuration options.

On-premise applications may be accessed through physical networks for virtual private networks (VPNs), for example, and may have access via an internal network or through a VPN.

Select on-premises applications may be internet-facing, and applications may be configured with single sign-on (SSO).

Some of the on-premise applications to the internet may be away from physical internal networks, and cloud applications may be configured with SSO. Access may be granted to managed and compliant/registered endpoints. For critical applications, it may be possible to add multi-factor authentication (MFA) for user access.

Unauthorized cloud service and applications risk may be assessed by the policy enforcement engine. Shadow IT risk may be assessed, and critical applications may be monitored and controlled by the policy enforcement engine.

The security policy enforcement engine may assess the risk of shadow IT applications deployed in the cloud to identify such applications for zero trust evaluation. The security policy enforcement engine may identify critical applications and ensure they are the first to be monitored, logged, and controlled.

Any applications may be available using least privilege access with continuous verification.

At the end of the zero trust journey, all applications may be available by following the concept of least privilege access and may have an “always verify” component of zero trust implemented with continuous verification.

Dynamic control may be in place for all applications with in-session monitoring and response. Dynamic control is a comprehensive IT Security process to control, monitor and record access to servers, databases and network devices. Properly implemented role-based access controls (RBACs) may include a lock down based on day, date, time and location. Monitoring and recording may be granular enough to capture keystrokes, text/graphical screen output, and mouse movements, in accordance with relevant laws and/or with user consent.

Regarding infrastructure data, the infrastructure may include infrastructure as a service (IaaS), platform as a service (PaaS), internal sites, containers, serverless computing, just-in-time (JIT) and version control, and the like. Infrastructure represents a critical threat vector. IT Infrastructure, whether on-premises or multi-cloud, may be defined as all the hardware (physical, virtual, containerized), software (open source, first- and third-party, PaaS, SaaS), micro-services (functions, APIs), networking infrastructure, facilities, etc. that are required to develop, test, deliver, monitor, control, or support IT services.

Every component may be assigned an application identity—and may be configured and deployed consistently. The security policy enforcement engine may use a policy that is assigned and enforced when creating resources/workloads. Policies can require tags to be applied to a resource upon creation, mandate resource group assignment, as well as restrict/direct technical characteristics, such as regions allowed, VM specifications (e.g., VM type, disks, network policies applied).

The security policy enforcement engine may monitor infrastructure components and may generate alerts indicating abnormal behavior. The security policy enforcement engine may establish rules for monitoring and generating alerts, allowing for identifying when a resource is displaying unexpected behavior.

The zero trust system may integrate logs and alerts with a security information event management (SIEM), and a security orchestration automated response (SOAR) solution may allow a Cybersecurity Incident Response Team (CIRT) to work from a single pane of glass to monitor security events across an enterprise.

Granular visibility and access control may be available across workloads.

On the access control side, Role-Based Access Control (RBAC) can be employed to assign permissions to resources. This allows permissions to be assigned and revoked uniformly at the individual and group levels by using a variety of built-in or custom roles.

Access to resources may require Just-In-Time techniques. Personnel may use administrative access sparingly. When administrative functions are required, users may receive temporary administrative access. (JIT).

The zero trust system may implement a targeted reduction in the number of users with administrative permissions (e.g., JEA). The security policy enforcement engine may audit elevated permission accounts and roles, and may provide awareness of how administrative permissions are being used, where these permissions are still necessary, as well as providing a roadmap for how to operate more securely.

Unauthorized deployments may be blocked, and alerts may be triggered by the policy enforcement engine.

The security policy enforcement engine may have the ability to block unauthorized deployments and trigger alerts to make users aware of the issues.

The security policy enforcement engine may implement governance around how resources are deployed, ensuring that only approved resources can be deployed.

User and resource access may be segmented for any workload. For example, network segmentation may be an overall approach.

Some initial requirements may include: Access to data, networks, services, utilities, tools, and applications may be controlled by authentication and authorization mechanisms. Data may be encrypted in transit and at rest. Network traffic flows may be restricted. Security teams may be granted visibility into all assets. Monitoring and auditing may be enabled and correctly configured according to prescribed organizational guidance. Anti-malware should be up to date and running. Vulnerability scans should be performed, and vulnerabilities remediated, according to prescribed organizational guidance.

Regarding network data, any data may be accessed over network infrastructure. Networking controls can provide critical controls to enhance visibility and help prevent attackers from moving laterally across the network. Networks may be segmented (e.g., in-network micro-segmentation), and real-time threat protection may be deployed, along with end-to-end encryption, monitoring, and analytics.

For Known Threats: Go forward DMZ firewalls, IPDS, ACLs--block list, network environment may filter for known threats. Desktop/server agents such as Anti-Virus A/V, Endpoint Detection Response, EDR, XDR, MDR, and/or other detection and response tools also may filter for known threats.

Access to resources may require JIT/JEA. The zero trust system may use least-privileged access, and may limit user access with Just-In-Time and Just-Enough-Access (JIT/JEA), risk-based adaptive polices, and data protection to protect both data and productivity. Users may have elevated access when necessary to perform the necessary task. The zero trust system may consider enabling in routers or Admin/root on endpoints and servers.

For micro-segmentation, users and systems may have limited access necessary for a project. All web servers may not need to talk to each other, and the same may apply to application servers and database servers. Projects may receive “tags,” for example “accounting,” and those systems can interact as necessary. The accounting systems may not need to interface with all other systems. These concepts allow for building micro-perimeters that are enforceable on-premise or in the cloud.

User to application internal traffic may be encrypted, moving towards all traffic encryption. Encryption may be implemented to ensure that user-to-application internal traffic is encrypted. Secure communication such as HTTPS,SSH, and the like, may be implemented, and open text protocols such as telnet may be removed.

The zero trust system may provide end state network protection by ensuring that all traffic is encrypted. Application backend traffic may be encrypted between virtual networks, traffic between on-premises and cloud including configuring a site-to-site VPN for cloud-based private connections (e.g., used for peering).

Analytics-based threat protection may expand threat detection by enabling ML and/or AI based frameworks to generate baselines, detect volumetric traffic floods, and apply automatic mitigations.

Still referring to FIG. 1, a threat intelligence engine may be triggered by an identified policy violation. In particular, when the security policy enforcement engine detects a violation of a security policy, the threat intelligence engine may be triggered to assess the threat of the violation. Significance of a threat may be based on a number of times the violation has occurred, the type of violation, data or other resources impacted, and the like. When a threat is determined to be significant, the threat intelligence engine may facilitate the generation of notifications to users for further investigation of the violation, may automatically shut off access to devices, resources, and the like, may deactivate or limit access of user accounts or devices, may alter user or device roles, and the like to mitigate the threat.

Still referring to FIG. 1, the security policy enforcement engine and the threat intelligence engine may refer to software, machine learning, and hardware used to implement the functions described herein for zero trust security enforcement. The security policy enforcement engine and the threat intelligence engine may include any suitable processor-driven device including, but not limited to, a server device, a serverless device (e.g., elastic computing device), a mobile device or a non-mobile, e.g., a static device, a personal computer, a desktop computer, a mobile computer, a laptop computer, a notebook computer, a tablet computer, a server computer, a handheld computer, a handheld device, an on-board device, an off-board device, a consumer device, a mobile or portable device, a non-mobile or non-portable device, a non-desktop computer, or the like.

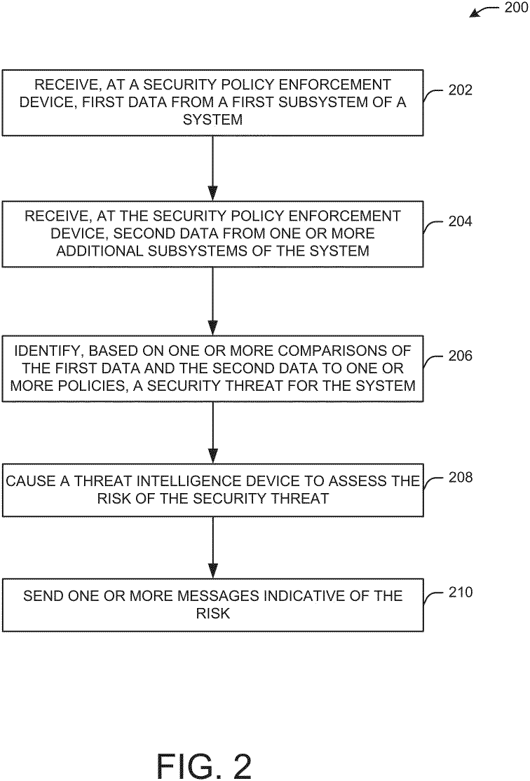

FIG. 2 is a flowchart illustrating a process 200 for zero trust security policy enforcement.

At block 202, a device (e.g., the security policy enforcement engine of FIG. 1) may receive first data from a first subsystem of a system. For example, the first subsystem may be an identities system (e.g., IAM, etc.), a devices subsystem (e.g., managed and/or unmanaged devices), a data subsystem, an applications subsystem, an infrastructure subsystem, a network subsystem, or another subsystem of a larger system (e.g., as shown in FIG. 1). The subsystem may have its own dedicated policy enforcement component different than the device, which may collect data from other subsystems.

At block 204, the device may receive second data from one or more additional subsystems of the system. For example, the first subsystem may be an identities system (e.g., IAM, etc.), a devices subsystem (e.g., managed and/or unmanaged devices), a data subsystem, an applications subsystem, an infrastructure subsystem, a network subsystem, or another subsystem of a larger system (e.g., as shown in FIG. 1). The subsystem may have its own dedicated policy enforcement component different than the device, which may collect data from other subsystems. The one or more additional subsystems may be different from the first subsystem and from one another (when there are multiple subsystems in addition to the first subsystem). The data collected from the first subsystem and any additional subsystems may be different. Some data may be encrypted, labeled, and/or classified. The first and second data may be received by the device from application programming interface (API) or other activity logs, JavaScript Object Notifications (JSONs), telemetry, governance/compliance data, threat data, and the like.

At block 206, the device may identify one or more security threats for the system by comparing the data received from the subsystems to one or more policies. The one or more policies may provide rules for identifying a security threat. For example, an identity policy may govern IAM and other user rules. A device policy may govern device compliance and risk. A data policy may govern encryption, classification, and labeling of structured and unstructured data. An application policy may govern which devices and users have access to certain applications, at which times, and the like. A network policy may govern segmentation rules. An infrastructure policy may govern access and runtime control. When the device determines that the first and second data show that a policy was not complied with, the device may identify a security threat.

At block 208, the device may cause a threat intelligence device (e.g., the threat intelligence engine of FIG. 1) to assess the risk of the security threat. The threat intelligence device may be triggered by an identified policy violation. In particular, when the device detects a violation of a security policy, the threat intelligence device may be triggered to assess the threat of the violation. Significance of a threat may be based on a number of times the violation has occurred, the type of violation, data or other resources impacted, and the like.

At block 210, when a threat is determined to be significant, the device or the threat intelligence device may facilitate the generation of notifications to users for further investigation of the violation, may automatically shut off access to devices, resources, and the like, may deactivate or limit access of user accounts or devices, may alter user or device roles, and the like to mitigate the threat.

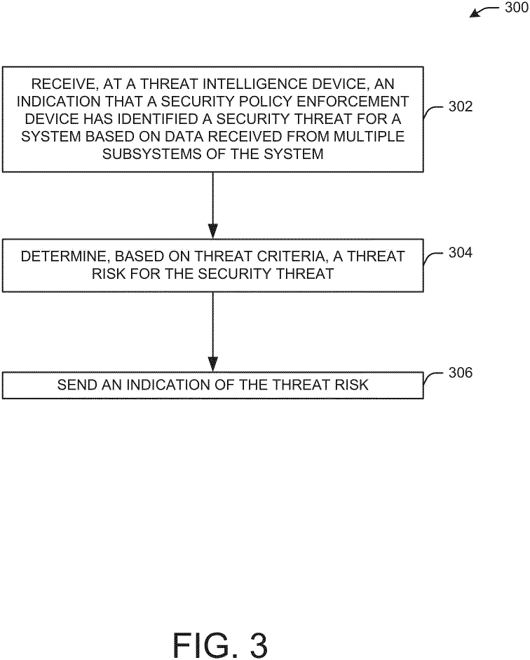

FIG. 3 is a flowchart illustrating a process 300 for zero trust security policy enforcement.

At block 302, a device (e.g., the threat intelligence engine of FIG. 1) may receive an indication that a security policy enforcement device (e.g., the security policy enforcement engine of FIG. 1) has identified a security threat. For example, the security policy enforcement device may be a centralized device that collects data from multiple subsystems, the subsystems having their own dedicated security policy service to analyze data for the respective subsystem. When the security policy enforcement device identifies a non-compliance with a policy, such may indicate the security threat, and may trigger the device to analyze the severity of the threat.

At block 304, the device may determine a threat risk for the security threat. For example, significance of a threat may be based on a number of times the violation has occurred, the type of violation, data or other resources impacted, and the like. In this manner, the device may use threat criteria to determine whether the security threat is more or less significant.

At block 306, the device may send an indication of the threat risk, or facilitate another device sending such an indication. When a threat is determined to be significant, the device may facilitate the generation of notifications to users for further investigation of the violation, may automatically shut off access to devices, resources, and the like, may deactivate or limit access of user accounts or devices, may alter user or device roles, and the like to mitigate the threat.

It is understood that the above descriptions are for purposes of illustration and are not meant to be limiting.

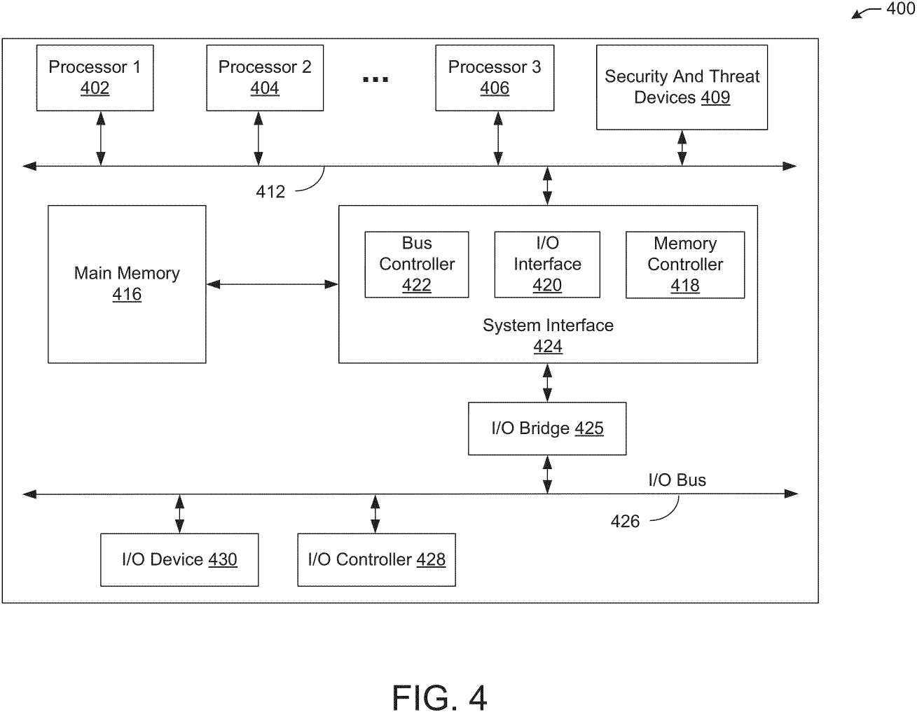

FIG. 4 is a block diagram illustrating an example of a computing device or computer system 400 which may be used in implementing the embodiments of the components of the network disclosed above. For example, the computing system 400 of FIG. 4 may represent at least a portion of the security policy enforcement engine and/or the threat intelligence engine shown in FIG. 1 and discussed above. The computer system (system) includes one or more processors 402-406 and one or more security and threat devices 409 (e.g., representing at least a portion of the security and policy enforcement engine and/or the threat intelligence engine of FIG. 1, capable of performing any operations described with respect to FIGS. 1-3). Processors 402-406 may include one or more internal levels of cache (not shown) and a bus controller 422 or bus interface unit to direct interaction with the processor bus 412. Processor bus 412, also known as the host bus or the front side bus, may be used to couple the processors 402-406 with the system interface 424. System interface 424 may be connected to the processor bus 412 to interface other components of the system 400 with the processor bus 412. For example, system interface 424 may include a memory controller 418 for interfacing a main memory 416 with the processor bus 412. The main memory 416 typically includes one or more memory cards and a control circuit (not shown). System interface 424 may also include an input/output (I/O) interface 420 to interface one or more I/O bridges 425 or I/O devices with the processor bus 412. One or more I/O controllers and/or I/O devices may be connected with the I/O bus 426, such as I/O controller 428 and I/O device 430, as illustrated.

I/O device 430 may also include an input device (not shown), such as an alphanumeric input device, including alphanumeric and other keys for communicating information and/or command selections to the processors 402-406. Another type of user input device includes cursor control, such as a mouse, a trackball, or cursor direction keys for communicating direction information and command selections to the processors 402-406 and for controlling cursor movement on the display device.

System 400 may include a dynamic storage device, referred to as main memory 416, or a random access memory (RAM) or other computer-readable devices coupled to the processor bus 412 for storing information and instructions to be executed by the processors 402-406. Main memory 416 also may be used for storing temporary variables or other intermediate information during execution of instructions by the processors 402-406. System 400 may include a read only memory (ROM) and/or other static storage device coupled to the processor bus 412 for storing static information and instructions for the processors 402-406. The system outlined in FIG. 4 is but one possible example of a computer system that may employ or be configured in accordance with aspects of the present disclosure.

According to one embodiment, the above techniques may be performed by computer system 400 in response to processor 404 executing one or more sequences of one or more instructions contained in main memory 416. These instructions may be read into main memory 416 from another machine-readable medium, such as a storage device. Execution of the sequences of instructions contained in main memory 416 may cause processors 402-406 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 406 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 416, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed:

1. A method for identifying network security threats, the method comprising:
receiving, at a policy enforcement device of a computer network, first data from a first subsystem of the computer network;
receiving, at the policy enforcement device, second data from a second subsystem of the computer network, the first subsystem different than the first subsystem;
identifying, by the policy enforcement device, based on a comparison of at least one of the first data or the second data to a security policy, a security threat to the computer network; and
causing, by the policy enforcement device, a threat intelligence device of the computer network to determine a risk of the security threat.

2. The method of claim 1, wherein the first subsystem comprises a second policy enforcement device unique to the first subsystem, and wherein the second subsystem comprises a third policy enforcement device unique to the second subsystem.

3. The method of claim 1, further comprising sending one or more messages indicative of the risk of the security threat.

4. The method of claim 1, wherein the first subsystem comprises an identity management subsystem.

5. The method of claim 1, wherein the first subsystem comprises a device management subsystem.

6. The method of claim 1, wherein the first subsystem comprises a data management subsystem.

7. The method of claim 1, wherein the first subsystem comprises an application management subsystem.

8. The method of claim 1, wherein the first subsystem comprises an infrastructure management subsystem.

9. The method of claim 1, wherein the first subsystem comprises a network management subsystem.

10. A system for identifying network security threats, the system comprising:
a threat intelligence device; and
a policy enforcement device, the policy enforcement device configured to:
receive first data from a first subsystem of the system;
receive second data from a second subsystem of the system, the first subsystem different than the first subsystem;
identify, based on a comparison of at least one of the first data or the second data to a security policy, a security threat to the system; and
cause the threat intelligence device to determine a risk of the security threat.

11. The system of claim 10, wherein the first subsystem comprises a second policy enforcement device unique to the first subsystem, and wherein the second subsystem comprises a third policy enforcement device unique to the second subsystem.

12. The system of claim 10, wherein at least one of the threat intelligence device or the policy enforcement device is further configured to send one or more messages indicative of the risk of the security threat.

13. The system of claim 10, wherein to identify the security threat comprises to determine that the first data or the second data are indicative of a violation of the security policy.

14. The system of claim 10, wherein the first subsystem comprises an identity management subsystem, and wherein the second subsystem comprises a device management subsystem, a data management subsystem, an application management subsystem, an infrastructure management subsystem, or a network management subsystem.

15. The system of claim 10, wherein the first data comprise user identity data, and wherein the second data comprise device identity data.

16. A device for identifying network security threats, the device comprising at least one processor coupled to memory, the at least one processor configured to:
receive first data from a first subsystem of a computer system;
receive second data from a second subsystem of the computer system, the first subsystem different than the first subsystem;
identify, based on a comparison of at least one of the first data or the second data to a security policy, a security threat to the computer system; and
cause a threat intelligence device of the computer system to determine a risk of the security threat.

17. The device of claim 16, wherein the first subsystem comprises a second policy enforcement device unique to the first subsystem, and wherein the second subsystem comprises a third policy enforcement device unique to the second subsystem.

18. The device of claim 16, wherein the at least one processor is further configured to send one or more messages indicative of the risk of the security threat.

19. The device of claim 16, wherein to identify the security threat comprises to determine that the first data or the second data are indicative of a violation of the security policy.

20. The device of claim 16, wherein the first data comprise user identity data, and wherein the second data comprise device identity data.
